(19) United States
(12) Patent Application Publication
(10) Pub. No.: US 2018/0225766 A1
(43) Pub. Date: Aug. 9, 2018

(54) ASSET MANAGEMENT OPERATION ASSISTANCE SYSTEM

(71) Applicant: NOMURA RESEARCH INSTITUTE, LTD., Tokyo (JP)

(72) Inventors: Yuya KUBOTERA, Kanagawa (JP); Kaname YOSHIDA, Kanagawa (JP); Kiyoto SHIMBA, Tokyo (JP); Tomohiko NAKAGAWA, Tokyo (JP)

(73) Assignee: NOMURA RESEARCH INSTITUTE, LTD., Tokyo (JP)

(21) Appl. No.: 15/947,215

(22) Filed: Apr. 6, 2018

Related U.S. Application Data
(63) Continuation of application No. PCT/JP2015/078930, filed on Oct. 13, 2015.

(51) Int. Cl. G06Q 40/06; G06Q 40/04; G06Q 10/06

(52) U.S. Cl. CPC G06Q 40/06; G06Q 10/0635; G06Q 40/04

(57) ABSTRACT

The present invention is an asset management operation assistance system for appropriately setting attribute information for financial assets held by a financial institution, and calculating a risk weight for each financial asset. A representative embodiment comprises: an attribute information database which retains attribute information relating to each of the asset names of financial assets; and a risk weight determination unit which acquires information relating to target asset names of financial assets to be managed, acquires attribute information relating to the target asset names from the attribute information database, sets a risk weight for each target asset name on the basis of the acquired attribute information and in accordance with a classification of the target asset name, which is established according to predetermined criteria, and outputs the set risk weight as a response.

### BACKGROUND

### Technical Field

The present invention relates to a technique for assisting asset management operations in financial institutions, in particular to a technique effectively applied to an asset management operation assistance system and an asset management operation assistance program for assisting the management operations of financial assets held by financial institutions.

### Related Art

Banks holding financial assets such as stocks, bonds, and investment trusts perform a risk assessment on the financial assets in conformity with Basel Accords. To this end, they give attribute information such as the type of issue and the business category of the issuer to the individual products and issues included in their funds and others in line with the classification under Basel Accords, and calculate risk weights in accordance with the attributes. With international capital mobility due to the economic globalization, it is necessary to grasp appropriately the attributes of financial assets to calculate proper risk weights of financial assets including foreign bonds and the like.

Conventionally, banks have given mainly manually attribute information to the financial assets held by themselves. For example, they refer to the attribute information provided by foreign vendors as necessary on an information processing terminal, and update the attribute information on their own financial assets when there is any addition or change. In some cases, each of banks may perform some or all of the operations using their uniquely developed information processing system.

As a technique relating to risk assessment of financial assets, for example, JP 2004-5626 A describes a bond investment analysis/credit risk quantitative analysis system for calculating the theoretical bond prices and expected loss amounts of individual issues, which has: a data storage unit that stores price data on government bonds and corporate bonds, issue attribute data on government bonds and corporate bonds, business category data on corporate bond issuers, and financial attribute data on corporate bond issuers; and an arithmetic operation unit that performs bond investment analyses and credit risk quantitative analyses based on the data input from the data storage unit under calculation conditions specified by a calculation condition specification unit.

### SUMMARY

Banks can calculate and assess the risk weights of their own financial assets by using the conventional technique and the like. To the end, however, they need to obtain the attribute information on the individual issues and the issuers.

However, such attribute information may be defined and classified under unique code schemes or item schemes, for example, by individual banks and asset management companies or by individual information processing systems developed and offered by vendors to assist the banks and asset management companies in asset management operations. In addition, the coverage of subject issues and the like are totally different under the present circumstances. The same thing can be said to domestic and foreign financial information vendors. For example, the information provided by foreign information vendors holding foreign bond information (for example, BLOOMBERG (registered trademark), Interactive Data (registered trademark), STANDARD & POOR'S (registered trademark), and THOMSON REUTERS (registered trademark)) is greatly different in code scheme and data coverage.

Therefore, it is very difficult to implement an information processing system that offers a versatile financial asset management operation service to a plurality of banks and asset management companies, for example.

An object of the present invention is to provide an asset management operation assistance system that gives appropriately attribute information to the financial assets held by a financial institution and calculate risk weights.

The foregoing and other objects and novel features of the present invention will be clarified by the description herein and the attached drawings.

A representative embodiment of the invention disclosed in the present application will be briefly overviewed as follows:

An asset management operation assistance system according to a representative embodiment of the present invention is an asset management operation assistance system for assisting the management operations of financial assets. The asset management operation assistance system includes: an attribute information holding unit that holds attribute information on individual issues of the financial assets; and a risk weight determination unit that acquires information on subject issues included in the financial assets to be managed, acquires the attribute information on the subject issues from the attribute information holding unit, sets risk weights to the individual subject issues in accordance with results of classification of the subject issues under a predetermined standard based on the acquired attribute information, and returns the risk weights.

The advantageous effect of the representative embodiment of the invention disclosed in the present application will be briefly described as follows:

That is, according to the representative embodiment of the present invention, it is possible to give appropriately attribute information to financial assets held by a financial institution and calculate risk weights.

### BRIEF DESCRIPTION OF DRAWINGS

FIG. 1 is a diagram illustrating an overview of a configuration example of an asset management operation assistance system in an embodiment of the present invention;

FIG. 2 is a flowchart outlining an example of a process for calculating and assessing a risk weight of a subject issue in an embodiment of the present invention;

FIG. 3 is a flowchart outlining an example of a double gearing determination process in an embodiment of the present invention;

FIG. 4 is a flowchart outlining an example of a securitized product identification process in an embodiment of the present invention; and

FIG. 5 is a flowchart outlining an example of a specific issuer identification process in an embodiment of the present invention.

### DETAILED DESCRIPTION

Embodiment of the present invention will be described below in detail with reference to the drawings. In all the drawings describing the embodiment, identical components are given identical reference signs, and duplicated descriptions thereof will be omitted. Meanwhile, a component described with a reference sign with reference to one drawing may be mentioned again with the same reference sign in the description with reference to other drawings in which the component is not illustrated.

### <System Configuration>

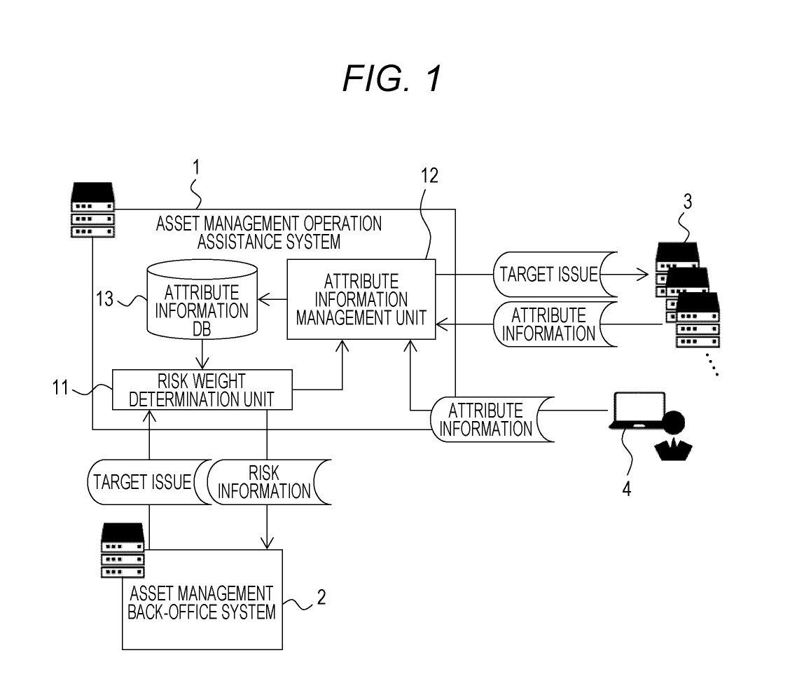

FIG. 1 is a diagram illustrating an overview of a configuration example of an asset management operation assistance system in an embodiment of the present invention. An asset management operation assistance system 1 is an information processing system that assists the management operations of financial assets held and managed by financial institutions such as banks and asset management companies, by giving attribute information to individual issues of the financial assets and calculating risk weights. In the embodiment, asset management operation assistance is provided by giving appropriately attribute information to individual issues of financial assets managed in an existing asset management back-office system 2 responsible for the management operations of the financial assets, and calculating and providing risk weights.

The asset management operation assistance system 1 is a server system including server devices and virtual servers built in cloud computing services, for example. The asset management operation assistance system 1 has a risk weight determination unit 11 that is implemented as software running on middleware not illustrated such as an operating system (OS), a database management system (DBMS), or a Web server program, an attribute information management unit 12, and others. The asset management operation assistance system 1 also has a data storage such as an attribute information database (DB) 13 implemented as a database or a file table.

The risk weight determination unit 11 has a function of giving corresponding attribute information to information on one or more subject issues acquired or passed from the asset management back-office system 2 via a network not illustrated such as a local area network (LAN) with reference to the attribute information DB 13, calculating risk weights based on the given attribute information by a determination method as described later, and returning the risk weights and the attribute information together as risk information. This process may be performed automatically at the timing when the information on the subject issue is acquired from the asset management back-office system 2 by daily night-time batch processing or may be performed manually at an arbitrary timing. This process may be skipped for labor savings when there is no change in the contents of the attribute information DB 13 since the previous process execution time.

The attribute information management unit 12 has a function of maintaining the contents of the attribute information DB 13. For example, the attribute information management unit 12 accesses an information vendor system 3 as an information processing system operated by a domestic or foreign information vendor via a network not illustrated such as the Internet to pass information on the subject issues and acquire attribute information on the type of the subject issue and the business category of the issuer, and registers the same with the attribute information DB 13. The attribute information DB 13 may hold not only the data acquired from the external information vendor system 3 but also existing data independently possessed by the business operator operating the asset management operation assistance system 1.

The information on the subject issues passed to the information vendor system 3 may be the information on all or some of the issues extracted from those currently registered with the attribute information DB 13 at that time or may be the information on all or some of the subject issues (for example, newly added issues) passed from the asset management back-office system 2 to the risk weight determination unit 11. This process may be performed automatically at a regular timing such as daily or may be performed manually at an arbitrary timing. This process may be performed as necessary at the timing when the information on the subject issues is passed from the risk weight determination unit 11. The attribute information management unit 12 may make an inquiry about the attribute information to one or more information vendor systems 3.

When the attribute information is acquired from all the information vendor systems 3 but there is no attribute information on any of the subject issues, the user such as a data analyst may access the attribute information management unit 12 via a data analyst terminal 4 that is an information processing terminal such as a personal computer (PC) to register manually the attribute information on the issue with the attribute information DB 13. In this case, the attribute information management unit 12 may notify the user such as a data analyst that the attribute information on some issues has not been acquired, by outputting the notification to the data analyst terminal 4.

When registering or updating in the attribute information DB 13 the attribute information on the individual issues acquired from the information vendor systems 3, the attribute information management unit 12 may classify the issues based on the attribute information under Basel Accords and give the attribute information such as the type of the issue and the business category of the issuer according to the classification. In this case, each of the information vendor systems 3 registers codes assigned to the attribute information based on the independent code scheme or item scheme in association with predetermined uniform standard codes (or converting them into predetermined standard codes). To make the associations, for example, the attribute information management unit 12 may hold the correspondence between the code scheme for the attribute information acquirable from the information vendor systems 3 and the predetermined standard codes and the conversion rules in a setting table or the like not illustrated.

The standard code scheme may be International Securities Identification Number (ISIN) codes that are internationally unified and prescribed under the international securities code specification ISO 6166 set forth by International Organization for Standardization (ISO), for example. Accordingly, it is possible to treat uniformly and transparently the issues including domestic and foreign investment trusts, for example, by the standard codes regardless of the sources of the attribute information.

### <Flow of Processing>

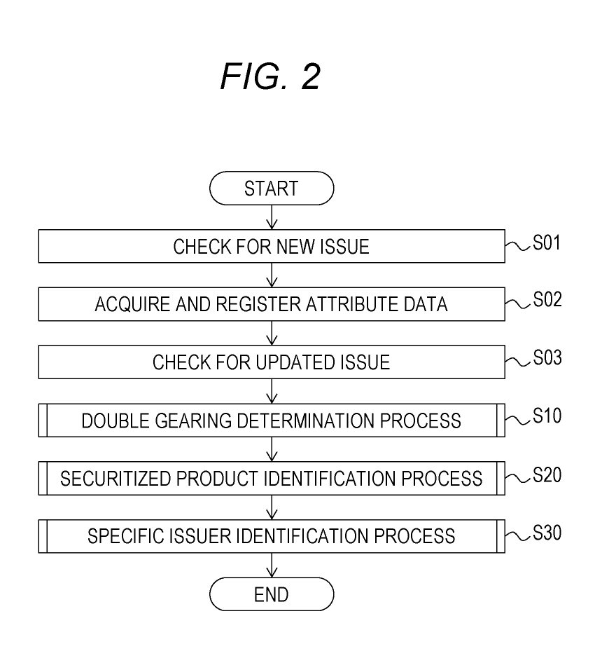

FIG. 2 is a flowchart outlining an example of a process for calculating and assessing the risk weights of subject issues in the asset management operation assistance system 1. When acquiring the information on a list of subject issues from the asset management back-office system 2 by a daily process or the like, the risk weight determination unit 11 first refers to the attribute information DB 13 to check if the list information includes any new issue with attribute information not yet registered (S01). When there is such a new issue, the attribute information management unit 12 acquires the attribute information on the new subject issue from the information vendor system 3 and registers the same with the attribute information DB 13 (S02). When the attribute information cannot be acquired from the information vendor system 3, the user such as a data analyst may register manually the attribute information via the data analyst terminal 4.

Next, the risk weight determination unit 11 checks if the attribute information on the individual subject issues included in the acquired list information and registered with the attribute information DB 13 has been updated since the previous processing time, and extracts a list of the updated issues (S03). The updated issues naturally include the issues newly added and registered in step S02. It is possible to determine whether the attribute information on the individual issues has been updated, for example, based on the time stamps at the time of updating the records of the attribute information registered with the attribute information DB 13. When the attribute information on each issue includes a plurality of items such as the type, the business category of the issuer, and ISIN code, for example, the issue with the attribute information in which any one of the items has been updated is extracted as updated issue.

After extracting the list of updated issues, the risk weight determination unit 11 performs a process for determining the attribute information on the issues in the list and calculating the risk weights. That is, the risk weight determination unit 11 re-calculates and updates only the risk weights of the issues newly added or updated in the registrations of the attribute information DB 13 based on the latest attribute information, and excludes the unchanged issues in the calculation of the risk weights. This increases efficiency of the process. The risk weight determination unit 11 may set not only the updated issues but all the subject issues acquired from the asset management back-office system 2 as processing targets every time or may set all the issues as processing targets at a predetermined timing such as once a month or only when the asset management back-office system 2 or the user provides an explicit instruction.

The process for determining the attribute information and calculating the risk weights is implemented by performing three determination steps, for example, a double gearing determination step (S10), a securitized product identification step (S20), and a specific issuer identification step (S30) in sequence.

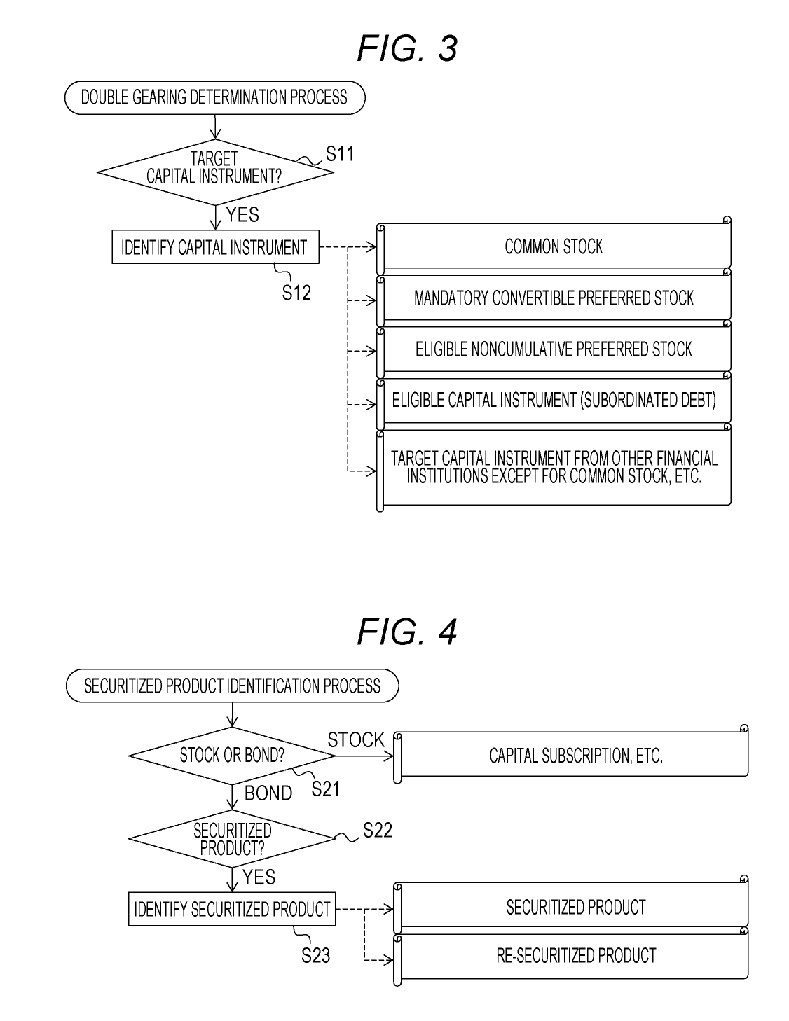

FIG. 3 is a flowchart outlining an example of the double gearing determination step (S10). In this case, the risk weight determination unit 11 determines whether the investment in the subject issue comes under the double gearing restriction (the prevention of chain reaction of financial crises by restricting the financing from one financial institution to another). When the investment comes under the double gearing restriction, the risk weight determination unit 11 sets the risk weight in accordance with the attribute information.

Specifically, the risk weight determination unit 11 first determines whether the subject issue falls under “target capital instruments issued by other financial institutions, etc.” under Basel Accords, based on the attribute information (mainly acquired from domestic and foreign information vendor systems 3) (S11). When the subject issue is not a target capital instrument, the risk weight determination unit 11 terminates the double gearing determination step (S10) and moves to the next securitized product identification step (S20).

When it is determined in step S11 that the subject issue is a target capital instrument, the data analyst manually determines the contents of the capital instrument, and the risk weight determination unit 11 sets the risk weight in accordance with the determination (S12). For example, the data analyst identifies the capital instrument with reference to the prospectus for the subject issue and the Web site of the issuer. When the identification is not possible, a researcher or the like may conduct further investigations. To identify the capital instrument, the risk weight determination unit 11 may notify the data analyst (or the data analyst terminal 4) accordingly.

As a result of the identification by the data analyst or the like, the subject issue is classified as “common stock”, “mandatory convertible preferred stock”, “eligible noncumulative preferred stock”, “eligible capital instrument (subordinated bond)”, or “target capital instruments from other financial institutions except for common stock, etc.” as illustrated in the drawing in line with the classification under Basel Accords. The identification result is input via the data analyst terminal 4 and registered with the attribute information DB 13.

When the subject issue is classified as “common stock”, the risk weight determination unit 11 sets the risk weight of the subject issue to 100% and selects the subject issue as a double gearing target. When the subject issue is classified as “mandatory convertible preferred stock”, the risk weight determination unit 11 sets the risk weight of the subject issue to 100% and selects the subject issue as a double gearing target if the subject issue satisfies the mandatory conversion clause and the other conditions announced by Basel III.

When the subject issue is classified as “eligible noncumulative preferred stock” and “eligible capital instrument (subordinated bond)”, the risk weight determination unit 11 sets the risk weight to 100% as a 15-year transitional measure and selects the subject issue as a double gearing target. When the subject issue is classified as “target capital instrument from other financial institutions except for common stock, etc.”, the risk weight determination unit 11 sets the risk weight to 250% but does not select the subject issue as a double gearing target. After setting the risk weight to the subject issue, the risk weight determination unit 11 terminates the overall process described in FIG. 2 on the subject issue.

FIG. 4 is a flowchart outlining an example of the securitized product identification step (S20). In this case, the risk weight determination unit 11 determines whether the issue judged not to come under the double gearing restriction in step S10 is “securitized product” or “re-securitized product”. When the issue falls under either of them, the risk weight determination unit 11 sets the risk weight in accordance with the attribute information.

Specifically, the risk weight determination unit 11 first determines whether the subject issue is “stock” or “bond” based on the information on the product category of the subject issue (S21). The information on the product category may be the information on the product category added in advance by the asset management back-office system 2 to the information on the subject issue acquired from the asset management back-office system 2, for example. When determining that the subject issue is “stock”, the risk weight determination unit 11 classifies the subject issue as “capital subscription, etc.” as illustrated in the drawing in line with the classification under Basel Accords, and registers the same with the attribute information DB 13. When classifying the subject issue as “capital subscription, etc.”, the risk weight determination unit 11 sets the risk weight of the subject issue to 100% and terminates the overall process described in FIG. 2 on the subject issue.

When determining in step S21 that the subject issue is not “stock” (but “bond”), the risk weight determination unit 11 determines whether the subject issue falls under “securitized product” or “re-securitized product” according to the classification under Basel Accords based on the attribute information (mainly acquired from the domestic and foreign information vendor systems 3) (S22). When the subject issue does not fall under “securitized product” or “re-securitized product”, the risk weight determination unit 11 terminates the securitized product identification step (S20) and moves to the next government and other issuers identification step (S30).

When the risk weight determination unit 11 determines in step S22 that the subject issue falls under “securitized product” or “re-securitized product”, the data analyst manually determines under which of them the subject issue falls, and the risk weight determination unit 11 sets the risk weight based on the determination (S23). For example, the data analyst determines whether the subject issue is “securitized product” or “re-securitized product” with reference to the Web site of the rating agency and the prospectus for the subject issue as necessary. When the identification is not possible, a researcher or the like may conduct further investigations. To determine whether the subject issue is “securitized product” or “re-securitized product”, the risk weight determination unit 11 may notify the data analyst (or the data analyst terminal 4) accordingly.

As a result of the determination by the data analyst, the subject issue is classified as “securitized product” or “re-securitized product” as illustrated in the drawing. The identification result is input via the data analyst terminal 4 and registered with the attribute information DB 13. The classification is made depending on whether the subject issue fits the definition of “securitized product” or “re-securitized product”. According to the result, the risk weight determination unit 11 sets the risk weight of the subject issue based on the rating given by the rating agency, and terminates the overall process described in FIG. 2 on the subject issue.

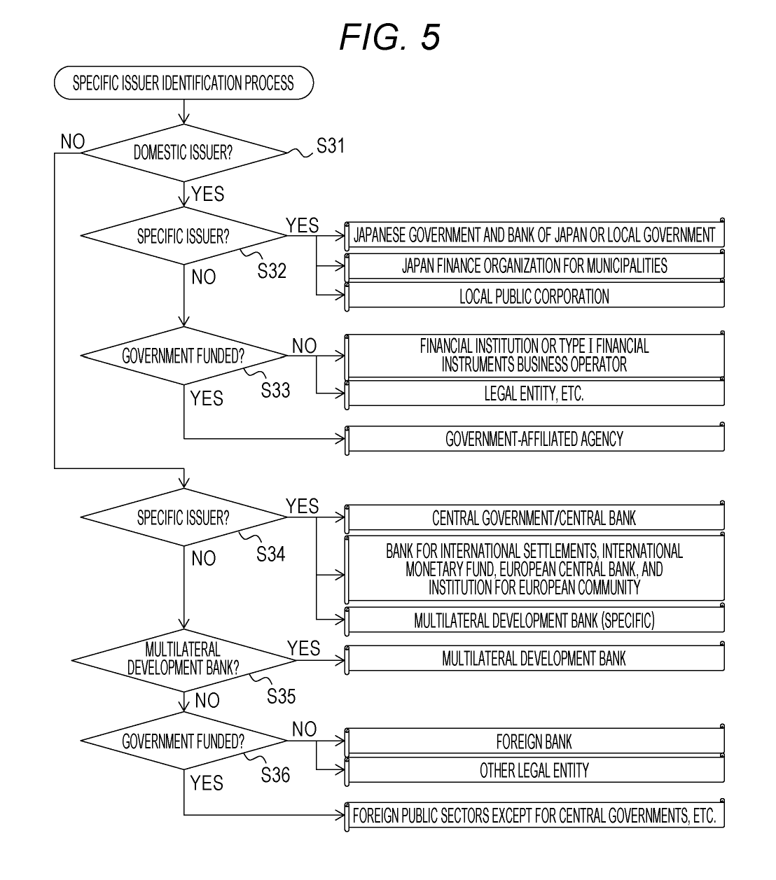

FIG. 5 is a flowchart outlining an example of the specific issuer identification step (S30). In this case, when determining in step S20 that the issuer of the subject issue is not “securitized product” or “re-securitized product”, the risk weight determination unit 11 identifies and classifies the issuer in line with the announcement under Basel Accords, and sets the risk weight according to the attribute information.

Specifically, the risk weight determination unit 11 first determines whether the issuer of the subject issue is a domestic issuer or a foreign issuer based on the attribute information (mainly acquired from the domestic and foreign information vendor systems 3) (S31). When determining that the subject issuer is a foreign issuer, the risk weight determination unit 11 moves to step S34 described later to perform a process relating to foreign issuer. When determining that the subject issuer is a domestic issuer, the risk weight determination unit 11 then determines whether the issuer is an specific issuer based on the attribute information (mainly acquired from the domestic information vendor systems 3) (S32).

When determining the issuer is a specific issuer, the risk weight determination unit 11 classifies the issuer of the subject issue as “Japanese government and Bank of Japan or local government”, “Japan Finance Organization for Municipalities”, or “local public corporation”, and registers the same with the attribute information DB 13. When classifying the issuer as “Japanese government and Bank of Japan or local government”, the risk weight determination unit 11 sets the risk weight of the subject issue to 0% in yen terms. When classifying the issuer as “Japan Finance Organization for Municipalities” or “local public corporation”, the risk weight determination unit 11 sets the risk weight of the subject issue to 10% in yen terms. Then, the risk weight determination unit 11 terminates the overall process described in FIG. 2 on the subject issue.

When not determining in step S32 that the issuer is a specific issuer, the risk weight determination unit 11 then determines whether the issuer is a government-funded issuer based on the attribute information (mainly acquired from the domestic information vendor systems 3) (S33). When not determining that the issuer is a government-funded issuer, the risk weight determination unit 11 classifies the issuer of the subject issue as “financial institution or Type I financial instruments business operator” or “legal entity, etc.” in line with the classification under Basel Accords, and registers the same with the attribute information DB 13. When determining that the issuer is a government-funded issuer, the risk weight determination unit 11 classifies the issuer as “government-affiliated agency” and registers the same with the attribute information DB 13.

When classifying the issuer as “financial institution or Type I financial instruments business operator”, the risk weight determination unit 11 sets the risk weight of the subject issue based on the rating given by the country (Japan in this case). When classifying the issuer as “legal entity, etc.”, the risk weight determination unit 11 sets the risk weight of the subject issue based on the rating given by the rating agency. When classifying the issuer as “government-affiliated agency”, the risk weight determination unit 11 sets the risk weight of the subject issue to 10% in yen terms. Then, the risk weight determination unit 11 terminates the overall process described in FIG. 2 on the subject issue.

When determining in step S31 that the issuer is a foreign issuer, the risk weight determination unit 11 determines, as in the process on the domestic issuer described above, whether the issuer is a specific issuer based on the attribute information (mainly acquired from the foreign information vendor systems 3) (S34).

When determining that the issuer is a specific issuer, the risk weight determination unit 11 classifies the issuer of the subject issue as “central government/central bank”, “Bank for International Settlements, International Monetary Fund, European Central Bank, or institution for the European Community”, or “multilateral development bank (specific)”, and registers the same with the attribute information DB 13. When classifying the issuer as “central government/central bank”, the risk weight determination unit 11 sets the risk weight of the subject issue based on the rating given by the country (the country of the issuer in this case). When classifying the issuer as “Bank for International Settlements, International Monetary Fund, European Central Bank, or institution for European Community” or “multilateral development bank (specific)”, the risk weight determination unit 11 sets the risk weight of the subject issue to 0%. Then, the risk weight determination unit 11 terminates the overall process described in FIG. 2 on the subject issue.

When not determining in step S34 that the issuer is a specific issuer, the risk weight determination unit 11 then determines whether the issuer is “multilateral development bank” based on the attribute information (mainly acquired from the foreign information vendor systems 3) (S35). When determining that the issuer is “multilateral development bank”, the risk weight determination unit 11 classifies the issuer of the subject issue as “multilateral development bank” as illustrated in the drawing in line with the classification under Basel Accords, and registers the same with the attribute information DB 13. When classifying the issuer as “multilateral development bank”, the risk weight determination unit 11 sets the risk weight of the subject issue based on the rating given by the rating agency.

When not determining in step S35 that the issuer is “multilateral development bank”, the risk weight determination unit 11 then determines whether the issuer is a government-funded issuer based on the attribute information (mainly acquired from the foreign information vendor systems 3) (S36). When not determining that the issuer is a government-funded issuer, the risk weight determination unit 11 classifies the issuer of the subject issue as “foreign bank” or “other legal entities” as illustrated in the drawing in line with the classification under Basel Accords, and registers the same with the attribute information DB 13. When determining that the issuer is a government-funded issuer, the risk weight determination unit 11 classifies the issuer of the subject issue as “foreign public sectors except for central governments”, and registers the same with the attribute information DB 13.

When classifying the issuer as “foreign bank” or “foreign public sectors except for central governments”, the risk weight determination unit 11 sets the risk weight of the subject issue based on the rating given by the country (the country of the issuer in this case). When classifying the issuer as “other legal entities”, the risk weight determination unit 11 sets the risk weight of the subject issue based on the rating given by the rating agency. Then, the risk weight determination unit 11 terminates the overall process described in FIG. 2 on the subject issue.

In the foregoing descriptions of the process flows with reference to FIGS. 2 to 5, the risk weights are mere examples but the risk weights may be registered or updated as appropriate in accordance with the requirements for the risk assessment.

As described above, according to the asset management operation assistance system 1 in an embodiment of the present invention, it is possible to give the data acquired from the domestic and foreign information vendor systems 3 as attribute information to the individual issues of the financial assets held and managed by financial institutions such as banks and asset management companies in association with the globally unified code scheme such as ISIN codes, and calculate the risk weights as automatically as possible, thereby to increase the efficiency of the financial asset management operations. It is also possible to offer such functions as versatile services to a plurality of banks and asset management companies, for example.

The invention devised by the inventor has been specifically described so far based on the embodiment. However, it is needless to say that the present invention is not limited to the foregoing embodiment but can be modified in various manners without deviating from the gist of the present invention. For example, the foregoing embodiment has been described in detail for the ease of understanding the present invention, and the present invention is not necessarily limited to the embodiment including all the components described above. In addition, some of the components of the foregoing embodiment can be added to another embodiment, deleted, or replaced by those of another embodiment.

The present invention is applicable to an asset management operation assistance system for assisting the management operation of financial assets held by a financial institution.

What is claimed is:

1. An asset management operation assistance system for assisting management operations of financial assets, comprising:
an attribute information holding unit that holds attribute information on individual issues of the financial assets; and
a risk weight determination unit that acquires information on subject issues included in the financial assets to be managed, acquires the attribute information on the subject issues from the attribute information holding unit, sets risk weights to the individual subject issues in accordance with results of classification of the subject issues under a predetermined standard based on the acquired attribute information, and returns the risk weights.

2. The asset management operation assistance system according to claim 1, wherein
the predetermined standard corresponds to classification under Basel Accords.

3. The asset management operation assistance system according to claim 1, further comprising
an attribute information management unit that acquires attribute information on the individual issues of financial assets from one or more external information vendor systems and records the acquired attribute information in the attribute information holding unit.

4. The asset management operation assistance system according to claim 3, wherein
the attribute information management unit records the attribute information acquired from the information vendor systems in the attribute information holding unit in association with code values in a uniform code scheme.

5. The asset management operation assistance system according to claim 3, wherein
the information vendor systems include domestic and foreign information vendor systems.

6. The asset management operation assistance system according to claim 3, wherein
when no attribute information on a specific subject issue is included in the attribute information acquired from all the information vendor systems, the attribute information management unit accepts an input of the attribute information from the outside.

7. The asset management operation assistance system according to claim 2, further comprising
an attribute information management unit that acquires attribute information on the individual issues of financial assets from one or more external information vendor systems and records the acquired attribute information in the attribute information holding unit.

8. The asset management operation assistance system according to claim 7, wherein
the attribute information management unit records the attribute information acquired from the information vendor systems in the attribute information holding unit in association with code values in a uniform code scheme.

9. The asset management operation assistance system according to claim 7, wherein
the information vendor systems include domestic and foreign information vendor systems.

10. The asset management operation assistance system according to claim 7, wherein
when no attribute information on a specific subject issue is included in the attribute information acquired from all the information vendor systems, the attribute information management unit accepts an input of the attribute information from the outside.
